(19) United States
(12) Patent Application Publication
(10) Pub. No.: US 2026/0138182 A1
(43) Pub. Date: May 21, 2026

(54) METHOD TO INCREASE THE SURFACE AREA OF LITHIUM METAL

(71) Applicant: Enpower Greentech, Inc., New York, NY (US)

(72) Inventors: Yang Wang, Ann Arbor, MI (US); Brendan T. Skelly, Plymouth, MI (US); Zhendong Hu, Ann Arbor, MI (US); Yong Che, Ann Arbor, MI (US)

(21) Appl. No.: 18/953,350

(22) Filed: Nov. 20, 2024

(51) Int. Cl. B22F 9/06; B22F 1/05; H01M 4/38; H01M 4/62

(52) U.S. Cl. CPC B22F 9/06; B22F 1/05; H01M 4/382; H01M 4/628; B22F 2201/11; B22F 2301/054; B22F 2304/10; B22F 2304/15; B22F 2998/10

(57) ABSTRACT

Disclosed is a method to increase the surface area of lithium metal. The method includes at least four steps. The first step is melting bulk lithium metal. The second step is adding a particle stabilizing agent to the molten lithium. Alternatively, the particle stabilizing agent can be heated to a temperature above the melting point of the lithium metal and then the bulk lithium material is added to the heated particle stabilizing agent. The third step is agitating the mixture until the lithium particles that form are the desired size. The final step involves cooling the lithium particles to form stabilized lithium particles thereby increasing the surface area of the lithium metal.

### CROSS REFERENCE TO RELATED APPLICATIONS

None.

### FIELD OF THE DISCLOSURE

This disclosure relates generally to metal surface area modification, and more particularly, to methods for increasing the surface area of lithium metal and for its use in energy storage applications and other related applications.

### BACKGROUND OF THE DISCLOSURE

This section provides background information which is not necessarily prior art to the present disclosure.

The surface area of a metal may play a critical role in many technological applications wherein enhanced reactivity, catalytic activity, or electrochemical performance of the metal is required. By increasing the surface area of a metal, it is possible to improve its efficiency and functionality across a wide range of fields, including catalysis, energy storage, corrosion resistance, heat transfer, and sensor applications.

Several techniques are commonly used to increase the surface area of a metal. One is powdering of the metal, which involves grinding the metal into a fine powder, and this is frequently used in powder metallurgy and additive manufacturing. Nanostructuring of a metal is another and involves creating nanoparticles, nanowires, or nanoporous metals, which provide a high surface area-to-volume ratio and can be ideal for catalytic and energy storage applications. Chemical etching of a metal can be used to selectively remove surface layers thereby creating roughness or pores on the surface and it is commonly used in the formation of battery electrodes and sensors. Creating a metallic foam is another method to introduce porosity into the metal which significantly increases the surface area for use in heat exchangers and catalytic substrates. Lastly, electrochemical deposition techniques can be used to form dendritic or porous structures, which are useful in capacitors and batteries.

Lithium metal, due to its unique properties, holds great potential in several advanced applications. The low electrode potential of lithium metal makes it a key material for energy storage devices, particularly in lithium-metal batteries. Lithium anodes are expected to significantly increase energy density, offering a potential breakthrough in battery technology. Lithium-sulfur and lithium-air batteries could also benefit from the use of lithium metal anodes with an increased surface area, enabling improved charge/discharge rates and longer cycle life.

In addition to its use in batteries, lithium metal has applications in hydrogen storage applications and as a catalyst in certain chemical reactions. Increasing the surface area of lithium metal would enhance its ability to store hydrogen and improve its catalytic efficiency, making it more versatile for various energy applications.

Increasing the surface area of lithium metal presents several unique challenges due to its chemical properties. Lithium metal is a viscous material, making it very difficult to reduce the particle size through mechanical grinding. Most materials are lithiophobic, thus they repel molten lithium and make conventional methods like nanostructuring or metal foaming difficult. Lithium's high reactivity, especially when exposed to air or moisture, leads to instability and the formation of passivation layers that limit surface area enhancement of lithium metal. Electrochemical deposition can cause dendritic growth in lithium metal, which poses risks in battery applications, such as short circuits. Managing these issues is critical to effectively increasing the surface area of lithium metal.

### SUMMARY OF THE DISCLOSURE

This section provides a general summary of the present disclosure and is not intended to be interpreted as a comprehensive disclosure of its full scope or all features, aspects, and objectives.

Disclosed herein is a method to increase the lithium metal surface area by reducing molten lithium metal to smaller particles with the aid of one or more particle stabilizing agents. The method comprises at least four steps: the bulk lithium metal is heated above its melting point; one or more particle stabilizing agents are added to the molten lithium; the mixture is agitated with a desired speed and for a period of time; and then the lithium metal is cooled down after forming small particles with a desired size. Alternatively, the one or more particle stabilizing agents can be heated to a temperature above the melting point of the lithium metal first and then the bulk lithium metal is added to the heated one or more particle stabilizing agents followed by the steps of agitation and then cooling down once the desired particle size is reached.

### BRIEF DESCRIPTION OF THE DRAWINGS

The drawings described herein are for illustrative purposes only of selected aspects and not all implementations and are not intended to limit the present disclosure to only that actually shown. With this in mind, various features and advantages of example aspects of the present disclosure will become apparent to one processing ordinary skill in the art from the following written description and appended claims when considered in combination with the appended drawings, in which:

FIG. 1A shows bulk pure lithium metal at a melted stage and FIG. 1B shows the lithium metal after agitation for 180 seconds;

FIG. 2 is a schematic diagram illustrating a method to increase the surface area of lithium metal according to the present disclosure;

FIG. 3 displays a series of timed images, time shown in seconds in the upper left corner of each image, showing bulk lithium metal being converted into uniform small particles over a period of time of 180 seconds using a first particle stabilizing agent in accordance with the present disclosure;

FIG. 4A shows the lithium particles that developed after 180 seconds of agitation using a second particle stabilizing agent, FIG. 4B shows the lithium particles that developed after 180 seconds of agitation using a third particle stabilizing agent, and FIG. 4C shows the lithium particles that developed after 180 seconds of agitation using a combination of particle stabilizing agents;

FIG. 5 shows a Scanning Electron Microscopic (SEM) image of a lithium particle after 180 seconds agitation with a particle stabilizing agent in a method according to the present disclosure.

### DETAILED DESCRIPTION OF THE DISCLOSURE

In the following description, details are set forth to provide an understanding of the present disclosure.

For clarity purposes, example aspects are discussed herein to convey the scope of the disclosure to those skilled in the relevant art. Numerous specific details are set forth such as examples of specific components, devices, and methods, to provide a thorough understanding of various aspects of the present disclosure. It will be apparent to those skilled in the art that specific details need not be discussed herein, such as well-known processes, well-known device structures, and well-known technologies, as they are already well understood by those skilled in the art, and that example embodiments may be embodied in many different forms and that neither should be construed to limit the scope of the disclosure.

The terminology used herein is for the purpose of describing particular example aspects only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or feature is referred to as being “on,” “connected to,” “coupled to” “operably connected to” or “in operable communication with” another element or feature, it may be directly on, engaged, connected, or coupled to the other element or layer, or intervening elements or features may be present. In contrast, when an element is referred to as being “directly on”, “directly engaged to”, “directly connected to”, or “directly coupled to” another element or feature, there may be no intervening elements or layers present between them. Other words used to describe the relationship between elements should be interpreted in a like fashion (e.g., “between” versus “directly between”, “adjacent” versus “directly adjacent”, etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly and expressly indicated by the context. Thus, a first element, component, region, layer, or section discussed below could be termed a second element, component, region, layer, or section without departing from the teachings of the example embodiments.

For purposes of description herein, the terms “upper”, “lower”, “right”, “left”, “rear”, “front”, “vertical”, “horizontal”, and derivatives thereof shall relate to the invention as oriented in the FIGS. However, it is to be understood that the present disclosure may assume various alternative orientations and step sequences, except where expressly specified to the contrary. It is also to be understood that the specific devices and processes illustrated in the attached drawings, and described in the following specification are exemplary aspects of the inventive concepts defined in the appended claims. Hence, specific dimensions and other physical characteristics relating to the aspects disclosed herein are not to be considered as limiting, unless the claims expressly state otherwise.

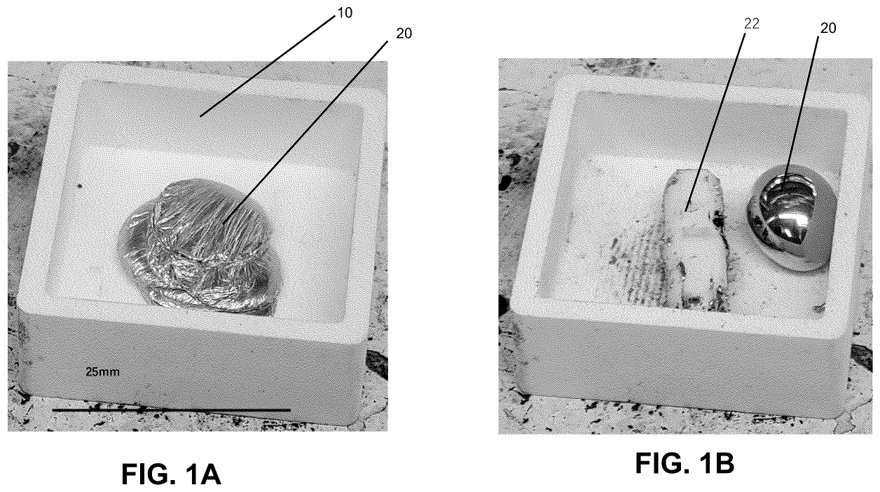

FIG. 1A and FIG. 1B demonstrate the difficulty of increasing the surface area of lithium metal by attempting to break down molten lithium in the absence of any particle stabilizing agent. A piece of lithium metal 20 was placed in an Al₂O₃ crucible 10 and heated above the lithium metal 20 melting point on a hot plate, not shown. A stirring bar 22 was used to agitate the molten lithium metal 20 in the crucible 10. During agitation, the lithium metal 20 remained largely in the form of a single sphere or ball, and occasionally it was broken to several smaller spheres. However, Al₂O₃ is lithiophobic to molten lithium metal 20, so the small lithium spheres were free to move inside the crucible 10 during the agitation. When a lithium sphere contacted another lithium sphere they immediately coalesced into a single sphere. Eventually, all the lithium spheres coalesced and became a single lithium sphere 20 as shown in FIG. 1B.

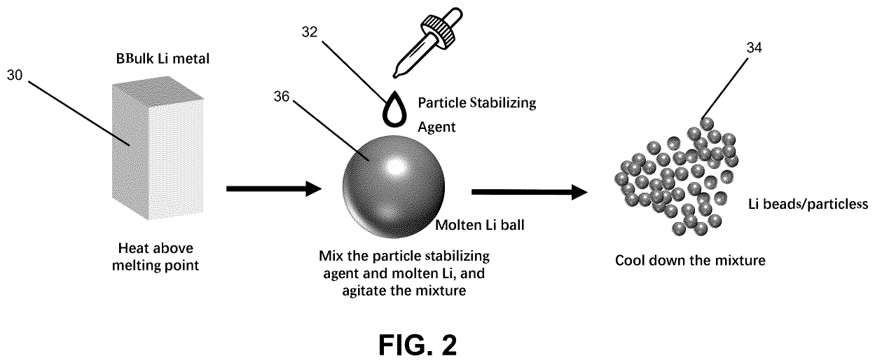

The disclosed method to increase the lithium metal surface area is illustrated in FIG. 2. In the first step, the bulk lithium metal 30 is heated to a temperature above its melting point, which is 180.50° C. In a second step, an appropriate amount of a particle stabilizing agent 32 is mixed with the molten lithium metal 36. Alternatively, the particle stabilizing agent 32 can be heated to a temperature above the melting point of the lithium metal 30 first and then the bulk lithium metal 30 is added to the particle stabilizing agent 32. In addition, a combination of one or more particle stabilizing agents can be used. The particle stabilizing agent or mixture of particle stabilizing agents can be dissolved in a solvent if desired. The solvent must have a boiling point that is above the melting temperature of the lithium metal. The mixture of molten lithium metal 36 and particle stabilizing agent 32 is then mixed and agitated to break up the molten lithium metal 30. Once the lithium metal 30 is converted to a plurality of smaller particles 34 by the agitation and stabilized by the particle stabilizing agent 32 and after the mixture achieves the desired particle size, the agitation and the heating are turned off and the particles 34 are allowed to cool. The particle stabilizing agent 32 allows the lithium metal particles 34 to remain as particles and prevents them from coalescing into a single sphere. The operational environment wherein the process of the present disclosure is conducted includes: in dry rooms, in glove boxes under argon gas, and in vacuum chambers.

The viscosity of the particle stabilizing agent in the operational environment, meaning at 25° C. at atmospheric pressure, is between 1 and 100,000 mPa·s. Suitable particle stabilizing agents must meet at least two criteria to facilitate the conversion of the lithium metal to stabilized particles. First, the particle stabilizing agent must have a boiling point temperature that is higher than the melting point of the lithium metal in the operational environment of the process. The melting point temperature of lithium metal is 180.50° C. under standard temperature and atmosphere conditions. Second, the particle stabilizing agent must either be completely inert to the lithium metal or react with the lithium metal to form a passive shell around it to prevent further reaction.

The crucible 10 used to hold the lithium and particle stabilizing agent during the method steps can be made of Al₂O₃, copper, stainless steel or nickel. The bulk lithium metal 30 can be in the shape of an ingot, a foil, a disc, or as irregular sized and shaped pieces. Examples of preferred particle stabilizing agents include, but are not limited to, polyester polymers, polyurethane polymers, styrene-maleic anhydride copolymers, modified siloxanes, siloxane polymers, and combinations of thereof. The volume ratio of the particle stabilizing agent to the molten lithium metal preferably ranges from 0.001 to 1.0 to 10000 to 1.0. The particle stabilizing agent allows for formation of stable small particles of lithium metal thereby increasing the surface area of the lithium metal compared to the bulk lithium metal. Agitation of the mixture of particle stabilizing agent and molten lithium metal can be realized by manual, magnetic or mechanical stirring devices.

### Example 1

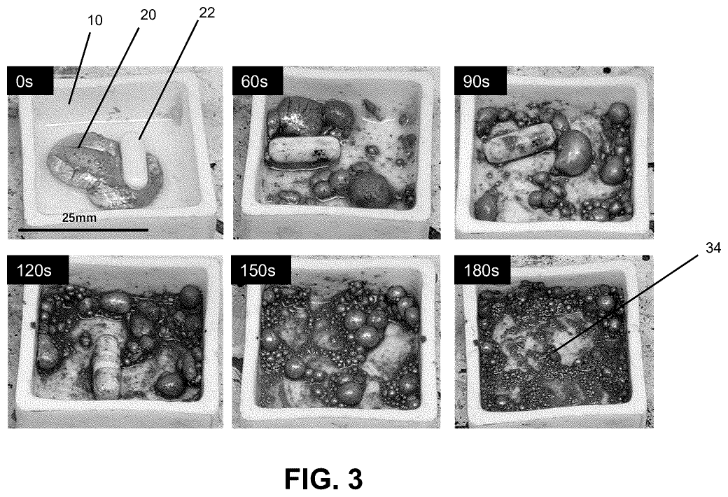

The steps of the method were carried out inside a glove box filled with argon gas. An Al₂O₃ crucible was cleaned with distilled water and degassed at 350° C. overnight in a vacuum oven. A hot plate with a magnetic stirring function was used to heat the crucible above 270° C. so that the bulk lithium metal can be melted in the crucible. A bulk lithium metal piece of around 6 cubic centimeters (cm³) in size and a polytetrafluoroethylene (PTFE) covered magnetic stirring bar were placed in the crucible. After the bulk lithium metal was melted, 2 ml of a particle stabilizing agent, polyester polymer BYK-LP C 25059, (BYK-CHEMIE GMBH), was dropped into the crucible. Then, the stirring bar was rotated at 50 rounds per minute. A series of photographic images were taken after stirring for 0, 60, 90, 120, 150 and 180 seconds and they are shown in FIG. 3 with the time displayed in the upper lefthand corner. The bulk molten lithium metal was converted into smaller parts after 60 seconds of agitation, but the particle size distribution was not uniform. Most of the lithium particles were below 5 millimeters (mm) while a few of them were larger than 10 mm. Further agitation kept splitting the lithium particles and creating a more uniform size distribution of the particles as is seen in the photos from longer time periods of agitation. After 180 seconds of stirring, most of the lithium particles were less than 1 mm as shown in the final photographic image of FIG. 3.

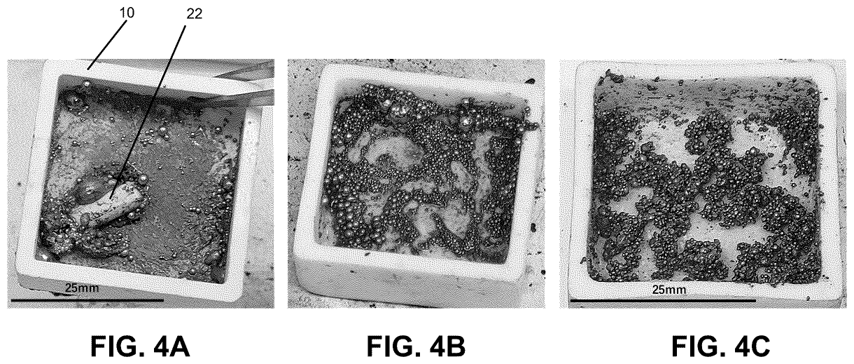

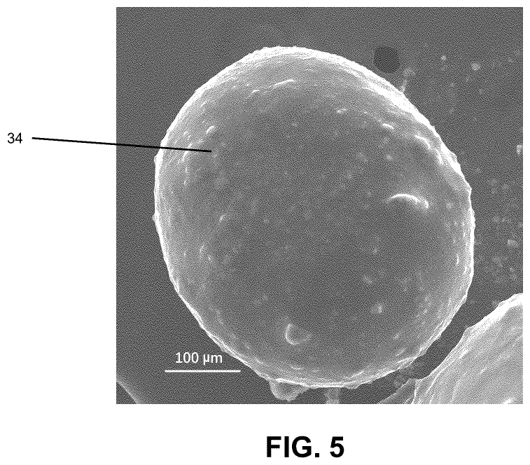

Other suitable examples of particle stabilizing agents include polyurethane polymers such as BYK-LP N 26270 (BYK-CHEMIE GMBH) or BYK-LP N 26340 (BYK-CHEMIE GMBH); styrene-maleic anhydride copolymers such as BYK-ET 3034 (BYK-CHEMIE GMBH); polyester polymers such as BYK-LP C 25059 (BYK-CHEMIE GMBH); and mixtures of polyurethane and polyester polymers such as a mixture of BYK-LP N 26340 (BYK-CHEMIE GMBH) and the polyester polymer BYK-LP C 25059 (BYK-CHEMIE GMBH). Using the method described above in Example 1 the particle stabilizing agents used were either BYK-LP N 26270, BYK-ET 3034, or a 1:1 mixture of BYK-LP N 26340 with BYK-LP C 25059. The results after 180 seconds of agitation with each are shown in FIGS. 4A, 4B and 4C respectively. All of the tested particle stabilizing agents increased the lithium surface area with 180 seconds of stirring, however, the effectiveness varied. The particle size of the lithium particles created with the polyurethane polymer BYK-LP N 26270 ranged from 5 mm to less than 1 mm, and the majority were above 3 mm, see FIG. 4A. With the styrene-maleic anhydride copolymer BYK-ET 3034, the size range of the lithium particles became narrower, and few of the lithium particles were larger than 3 mm, see FIG. 4B. The most uniform distribution of the lithium particle size was achieved using the mixture of polyurethane BYK-LP N 26340 and polyester BYK-LP C 25059 polymers, see FIG. 4C. An SEM image of a typical lithium particle produced according to the disclosed method is shown in FIG. 5. The lithium particle 34 has a spherical shape, and the diameter was around 100 micron (μm). The lithium particles can be made smaller in diameter by increasing the stirring speed or increasing the stirring time.

The lithium surface area increase factor with the different particle stabilizing agents is quantified below. Assuming the initial molten lithium is ball-shaped with a radius R, and it is broken down into small and uniform sized lithium particles with a radius r, then the total number of the lithium particles, N, is

$$N = \frac{\frac{4 π {R}^{3}}{3}}{\frac{4 π {R}^{3}}{3}} = {( \frac{R}{r} )}^{3}$$

Then, the lithium surface area increase factor, f, is determined as

$$f = \frac{N π {r}^{2}}{π {R}^{2}} = \frac{R}{r}$$

The radius R of the molten lithium ball was directly measured from the pictures. The average radius r of the small lithium particles was measured by the following method. A straight line, crossing as many lithium particles as possible, was drawn from one point to another point in the picture. The number of lithium particles on the straight line were counted and the line length was measured to determine the average radius of the particles. The surface area increase factor with several particle stabilizing agents is summarized in Table 1 below. The surface area increase factors of the examples ranged between 1.44 and 26.60. In our examples, the styrene-maleic anhydride copolymer particle stabilizing agent produced the highest surface area increase factor at 26.60. By starting with a larger volume of lithium metal and longer or faster agitation, one can have a larger surface area increase factor.

TABLE 1

| | | | Surface area increase |
|---|---|---|---|
| | Boiling | Viscosity | factor after 180 seconds |
| | Point | in mPa · s | of agitation in this |
| Particle stabilizing agent | (° C.) | at 25° C. | disclosure |
| White mineral oil | >218 | 17.9 | ~1.44 |
| UltraPro ® Food Grade | | | |
| White Mineral Oil | | | |
| Polyester polymer | >250 | 436 | ~9.17 |
| BYK-LP C 25059 | | | |
| Polyurethane polymer | >220 | 8020 | ~8.58 |
| BYK-LP N 26270 | | | |
| Mixture of | >250 | 9260 | ~23.13 |
| polyester polymer and | | | |
| polyurethane polymer | | | |
| BYK-LP C 25059 and | | | |
| BYK-LP N 26340 | | | |
| Styrene-maleic anhydride | >200 | 30000 | ~26.60 |
| copolymer | | | |
| BYK-ET 3034 | | | |

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

We claim:

1. A method to increase the surface area of lithium metal comprising the steps of:
a. melting bulk lithium metal at a temperature above the melting point of the lithium metal to form molten lithium metal;
b. mixing the molten lithium metal with one or more particle stabilizing agents;
c. agitating the mixture of molten lithium and one or more particle stabilizing agents to form a plurality of lithium metal particles;
d. cooling the lithium metal particles.

2. The method to increase the surface area of lithium metal according to claim 1, wherein the steps of the method are conducted under standard temperature and atmospheric pressure in a dry room, in a glove box filled with an inert gas, in a vacuum chamber, or in a combination thereof.

3. The method to increase the surface area of lithium metal according to claim 1, wherein the viscosity of the one or more particle stabilizing agents is between 1 and 100,000 mPa·s at a temperature of 25° C.

4. The method to increase the surface area of lithium metal according to claim 1, wherein the volume ratio of the one or more particle stabilizing agents to the molten lithium each ranges from 0.001 to 1.0 to 10000 to 1.0.

5. The method to increase the surface area of lithium metal according to claim 1, wherein the one or more particle stabilizing agents is selected from the group consisting of a polyester polymer, a polyurethane polymer, a styrene-maleic anhydride copolymer, a modified siloxane, a siloxane polymer, a mineral oil, and combinations thereof.

6. The method to increase the surface area of lithium metal according to claim 2, wherein the one or more particle stabilizing agents are dissolved in a solvent that has a boiling point above the melting point temperature of the lithium metal.

7. The method to increase the surface area of lithium metal according to claim 1, wherein the agitation of the mixture of lithium metal and the one or more particle stabilizing agents is conducted manually, magnetically, or mechanically.

8. The method to increase the surface area of lithium metal according to claim 1, wherein the size of the lithium particles after step d. ranges from 20 microns (μm) to 20 mm.
